(19) United States
(12) Patent Application Publication
(10) Pub. No.: US 2020/0073409 A1
(43) Pub. Date: Mar. 5, 2020

(54) UAV LANDING SYSTEM AND LANDING METHOD THEREOF

(71) Applicant: Coretronic Corporation, Hsin-Chu (TW)

(72) Inventor: YU-CHING MAI, Hsin-Chu (TW)

(21) Appl. No.: 16/558,171

(22) Filed: Sep. 2, 2019

(30) Foreign Application Priority Data
Sep. 3, 2018 (CN) 201811018861.7

(51) Int. Cl. G05D 1/06; G05D 1/00; B64C 39/02; G06T 7/62; G06T 7/90

(52) U.S. Cl. CPC G05D 1/0676; G05D 1/0094; B64C 39/024; B64C 2201/145; G06T 7/90; B64C 2201/18; G06T 7/62

(57) ABSTRACT

An UAV landing system includes an UAV and a target area. The target area includes a first reference area of a first color. An image below the UAV is captured to generate a reference image. The reference image includes at least two reference points located in a surrounding area of the reference image. A processor of the UAV determines whether the colors of the at least two reference points are all the first color. If the determined result is yes, the processor controls a controller of UAV to drive the UAV to move downward toward the target area. If the determined result is no, the processor determines whether the at least two reference points include the reference point of the first color. If the determined result is yes, the processor controls the controller to drive the UAV to fly along a flight adjustment direction.

### FIELD OF THE INVENTION

The invention relates to a landing system and landing method thereof, and more particularly to an UAV (Unmanned Aerial Vehicle) landing system and landing method thereof.

### BACKGROUND OF THE INVENTION

The UAV (Unmanned Aerial Vehicle) may be used to perform a variety of tasks in outdoor or indoor environments, such as surveillance and observation. The UAV can be remotely piloted by a pilot or can be automatically navigated and flew by programs and coordinates. The UAV may be equipped with cameras and/or detectors to provide images or information about weather, atmospheric conditions, radiation values, and more during the flight. The UAV may also include cargo hold for transporting payloads. Therefore, the diversified application potential of the UAV is constantly developing.

When the UAV is used in automatic flight surveillance, the UAV platform is often used for the UAV to park or charge. Therefore, how to make the UAV automatically and accurately land in a specific position is the focus of attention of the persons having ordinary skill in the relevant technical field.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

An objective of the invention is to provide an UAV landing system, which can make the UAV accurately landed in the target area.

Another objective of the invention is to provide an UAV landing method, which can make the UAV accurately landed in the target area.

Another objective of the invention is to provide an UAV, which can make the UAV accurately landed in the target area.

Other objectives and advantages of the invention may be further illustrated by the technical features disclosed in the invention.

In order to achieve one or a portion of or all of the objectives or other objectives, an embodiment of the invention provides an UAV (Unmanned Aerial Vehicle) landing system, including an UAV and a target area. The UAV includes a controller, a processor, and an image capture device, and the processor is coupled to the controller and the image capture device. The target area is used for the UAV to land. The target area includes a first reference area, and the color of the first reference area is a first color. The image capture device captures an image below the UAV to generate a reference image. The reference image includes at least two reference points, and the at least two reference points are located in a surrounding area of the reference image. The processor determines whether the colors of the at least two reference points are all the first color. If the determined result is yes, the processor controls the controller to drive the UAV to move downward toward the target area. If the determined result is no, the processor determines whether the at least two reference points include the reference point of the first color. If the determined result is yes, a direction from a center of the reference image to the reference point of the first color is a flight adjustment direction, and the processor controls the controller to drive the UAV to fly along the flight adjustment direction.

In order to achieve one or a portion of or all of the objectives or other objectives, another embodiment of the invention provides an UAV landing method for landing an UAV to a target area. The UAV includes a controller, a processor, and an image capture device. The processor is coupled to the controller and the image capture device. The target area is used for the UAV to land. The target area includes a first reference area, and the color of the first reference area is a first color. The UAV landing method includes the following steps. The image capture device captures an image below the UAV to generate a reference image. The reference image includes at least two reference points, and the at least two reference points are located in a surrounding area of the reference image. The processor determines whether the colors of the at least two reference points are all the first color. If the determined result is yes, the processor controls the controller to drive the UAV to move downward toward the target area. If the determined result is no, the processor determines whether the at least two reference points include the reference point of the first color. If the determined result is yes, a direction from a center of the reference image to the reference point of the first color is a flight adjustment direction, and the processor controls the controller to drive the UAV to fly along the flight adjustment direction.

In order to achieve one or a portion of or all of the objectives or other objectives, still another embodiment of the invention provides a UAV landing system, including an UAV and a target area. The UAV includes a controller, a processor, and an image capture device, and the processor is coupled to the controller and the image capture device. The target area is used for the UAV to land, and the target area includes at least one identification feature. The image capture device captures an image below the UAV to generate a reference image. The processor determines, according to a deep learning module, a feature image corresponding to the at least one identification feature in the reference image and obtains a confidence level value. If the confidence level value is sufficient, the processor controls the controller to drive the UAV to move toward the target area. If the confidence level value is insufficient, the processor controls the controller to drive the UAV to fly along a flight adjustment direction according to the deep learning module.

In order to achieve one or a portion of or all of the objectives or other objectives, still another embodiment of the invention provides a UAV landing method for landing an UAV to a target area. The UAV includes a controller, a processor, and an image capture device, the processor is coupled to the controller and the image capture device. The target area is used for the UAV to land. The target area includes at least one identification feature. The UAV landing method includes the following steps. The image capture device captures an image below the UAV to generate a reference image. The processor determines, according to a deep learning module, a feature image corresponding to the at least one identification feature in the reference image and obtains a confidence level value. If the confidence level value is sufficient, the processor controls the controller to drive the UAV to move toward the target area. If the confidence level value is insufficient, the processor controls the controller to drive the UAV to fly along a flight adjustment direction according to the deep learning module.

In order to achieve one or a portion of or all of the objectives or other objectives, still another embodiment of the invention provides an UAV (Unmanned Aerial Vehicle), including a controller, a processor, and an image capture device. The processor is coupled to the controller, and the image capture device is coupled to the processor. A target area is used for the UAV to land. The target area includes a first reference area, and the color of the first reference area is a first color. The image capture device captures an image below the UAV to generate a reference image. The reference image includes at least two reference points, and the at least two reference points are located in a surrounding area of the reference image. The processor determines whether the colors of the at least two reference points are all the first color. If the determined result is yes, the processor controls the controller to drive the UAV to move downward toward the target area. If the determined result is no, the processor determines whether the at least two reference points include the reference point of the first color. If the determined result is yes, a direction from a center of the reference image to the reference point of the first color is a flight adjustment direction, and the processor controls the controller to drive the UAV to fly along the flight adjustment direction.

In order to achieve one or a portion of or all of the objectives or other objectives, still another embodiment of the invention provides an UAV (Unmanned Aerial Vehicle), including a controller, a processor, and an image capture device. The processor is coupled to the controller, and the image capture device is coupled to the processor. A target area is used for the UAV to land, and the target area includes at least one identification feature. The image capture device captures an image below the UAV to generate a reference image. The processor determines, according to a deep learning module, a feature image corresponding to the at least one identification feature in the reference image and obtains a confidence level value. If the confidence level value is sufficient, the processor controls the controller to drive the UAV to move toward the target area. If the confidence level value is insufficient, the processor controls the controller to drive the UAV to fly along a flight adjustment direction according to the deep learning module.

In the UAV landing system and the UAV landing method of the invention, by analyzing the reference image captured by the image capture device to control the flight of the UAV, the UAV could accurately and automatically land on the target area.

Other objectives, features and advantages of The invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic diagram of an UAV landing system according to an embodiment of the invention;

FIG. 2 is a block diagram of an UAV of the UAV landing system according to an embodiment of the invention;

FIG. 3A to FIG. 3B show a schematic diagram of a landing state of the UAV landing system according to an embodiment of the invention;

FIG. 4A to FIG. 4F show a schematic diagram of another landing state of the UAV landing system according to an embodiment of the invention;

FIG. 5A to FIG. 5D show a schematic diagram of still another landing state of the UAV landing system according to an embodiment of the invention;

FIG. 6 shows a schematic diagram of an UAV landing system according to another embodiment of the invention;

FIG. 7 shows a flowchart of an UAV landing method according to an embodiment of the invention;

FIG. 8 shows a flowchart of an UAV landing method according to another embodiment of the invention;

FIG. 9 shows a flowchart of an UAV landing method according to still another embodiment of the invention;

FIG. 10 shows a schematic diagram of an UAV landing system according to still another embodiment of the invention;

FIG. 11 is a block diagram of an UAV of the UAV landing system according to still another embodiment of the invention;

FIG. 12 shows a schematic diagram of a landing state of the UAV landing system according to still another embodiment of the invention;

FIG. 13 shows a schematic diagram of another landing state of the UAV landing system according to still another embodiment of the invention;

FIG. 14 shows a schematic diagram of still another landing state of the UAV landing system according to still another embodiment of the invention;

FIG. 15 shows a schematic diagram of still another landing state of the UAV landing system according to still another embodiment of the invention;

FIG. 16 shows a schematic diagram of still another landing state of the UAV landing system according to still another embodiment of the invention;

FIG. 17 shows a flowchart of an UAV landing method according to still another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

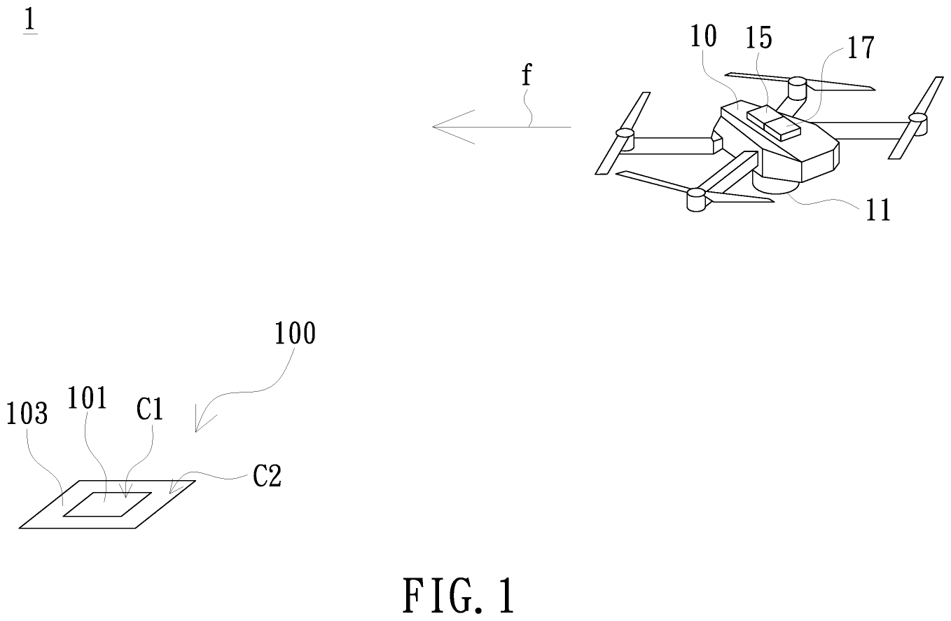

Referring to FIG. 1, which is a schematic diagram of a UAV landing system according to an embodiment of the invention. The UAV landing system 1 includes an UAV 10 and a target area 100. The UAV 10, for example, could include an image capture device 11 and a satellite navigation system 15, and the target area 100 is used for the UAV 10 to land. In the embodiment, the UAV 10, for example, could be guided to the upper area of the target area 100 by the satellite navigation system 15. Then, the UAV 10 could capture the image below the UAV 10 through the image capture device 11 to generate a reference image (not shown in FIG. 1). By analyzing the reference image to control the flight path of the UAV 10, the UAV 10 could accurately and automatically land on the target area 100. In addition, the UAV 10, for example, may be provided with a lidar 17 for guiding the UAV 10 to the upper area of the target area 100.

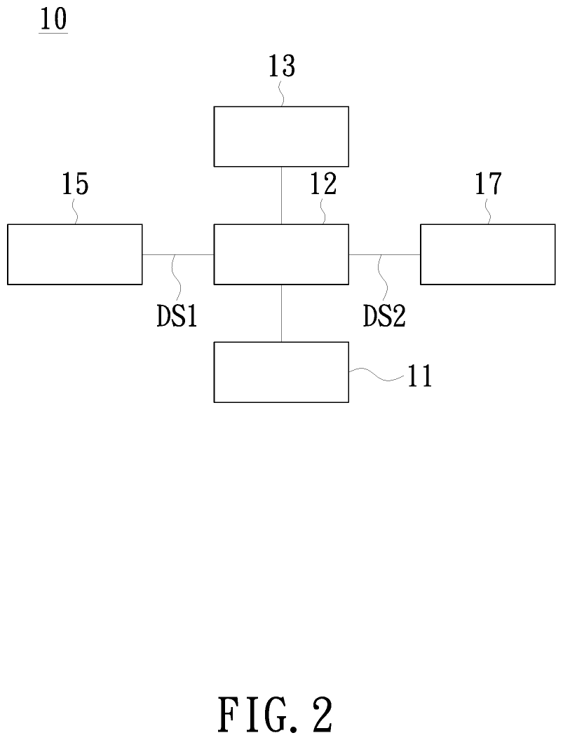

Referring to FIG. 2, which is a block diagram of the UAV 10 of the UAV landing system 1 shown in FIG. 1. The UAV 10 further includes a controller 13 and a processor 12, and the processor 12 is coupled to the controller 13, the image capture device 11, the satellite navigation system 15, and the lidar 17. In other embodiments, the UAV 10 may not provide with the lidar 17, to which the invention is not limited. As shown in FIG. 1, in the embodiment, the target area 100 includes a first reference area 101 and a second reference area 103 as an example, to which the invention is not limited. The second reference area 103 surrounds the first reference area 101, the color of the first reference area 101 is a first color C1, and the color of the second reference area 103 is a second color C2. The first reference area 101 and the second reference area 103, for example, could be implemented by attaching or coating materials, including the first color C1 and the second color C2 to the target area 100, to which the invention is not limited how the first reference area 101 and the second reference area 103 arranged. In the embodiment, the processor 12 may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array, and the controller 13 may be, for example, a central processing unit (CPU), a microprocessor, a digital signal processor (DSP), a programmable controller, a programmable logic device (PLD) or other similar devices or combination of these devices, which is used to control the elements inside the UAV.

As shown in FIG. 1 and FIG. 2, since the UAV 10 is not right above the target area 100, the processor 12, for example, could control the controller 13 to drive the UAV 10 to move toward the target area 100 according to the navigation signal DS1 provided by the satellite navigation system 15 and/or the orientation signal DS2 provided by the lidar 17. The processor 12, for example, could control the controller 13 to drive the UAV 10 to fly along the flight adjustment direction f by analyzing the navigation signal DS1 and/or the orientation signal DS2, so that the UAV 10 can fly to the upper area of the target area 100. The satellite navigation system 15, for example, could be implemented by the Global Positioning System (GPS), the Global Navigation Satellite System (GLONASS), or the BeiDou Navigation Satellite System (BDS), to which the invention is not limited. The satellite position coordinate of the target area 100, for example, could be preset to the UAV 10, so that the UAV 10 could fly to the upper area of the target area 100 by the satellite navigation system 15. The lidar 17, for example, could detect the orientation of the target area 100 by the optical remote sensing technology, so that the UAV 10 can fly to the upper area of the target area 100 by the lidar 17. In addition to the satellite navigation system 15 or the lidar 17, the invention does not exclude the possibility of guiding the UAV 10 to the upper area of the target area 100 through other possible navigation methods.

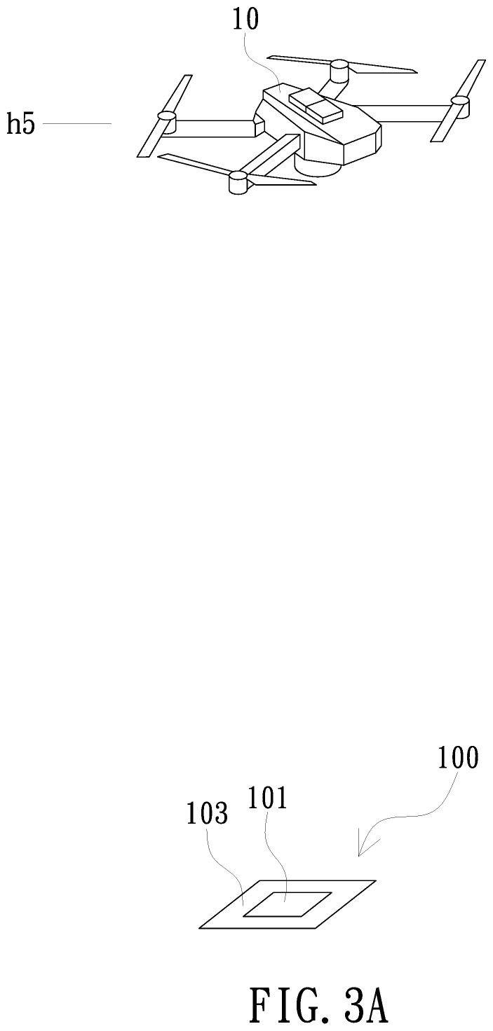

Referring to FIG. 2 and FIG. 3A to FIG. 3B, FIG. 3A to FIG. 3B show a schematic diagram of a landing state of the UAV landing system 1 shown in FIG. 1. As shown in FIG. 3A, after the UAV 10 reaches the area right above the target area 100, the UAV 10 can turn on the image capture device 11 to capture the image below the UAV 10. In the embodiment, the height of the UAV 10 relative to the target area 100 is the height h5, and FIG. 3B is a schematic diagram of the reference image R1 generated by the image capture device 11 capturing the image below the UAV 10 at this time. In the embodiment, the processor 12 receives the reference image R1 from the image capture device 11 and could set four reference points RP1, RP2, RP3, and RP4 on the reference image R1 for analysis, and the reference points RP1, RP2, RP3, and RP4 are located in the surrounding area of the reference image R1. However, the invention does not limit the number of reference points required for analysis of the reference image captured by the image capture device 11, and at least two reference points are located in the surrounding area of the reference image is sufficient.

Referring to FIG. 2 and FIG. 3B, when the processor 12 controls the controller 13 to drive the UAV 10 to the upper area of the target area 100 according to the navigation signal DS1 and/or the orientation signal DS2, and the processor 12 determines that the colors of the four reference points RP1, RP2, RP3, and RP4 are not the first color C1 or the second color C2, the processor 12 could control the controller 13 to drive the UAV 10 to move downward until the processor 12 determines that the reference points RP1, RP2, RP3, and RP4 of the reference image R1 captured by the image capture device 11 include the reference point of the first color C1 or the second color C2, and the processor 12 controls the controller 13 to drive the UAV 10 to stop moving downward. In the landing state shown in FIG. 3A to FIG. 3B, since the height h5 of the UAV 10 is too high, the colors of the reference points RP1, RP2, RP3, and RP4 of the reference image R1 captured by the image capture device 11 do not include the first color C1 or the second color C2. The reference points RP1, RP2, RP3, and RP4 of the reference image R1 are not located in the first reference area 101 or the second reference area 103. At this time, the UAV 10 could lower the height until the colors of the reference points include the first color C1 or the second color C2, and then continues the steps of accurate landing.

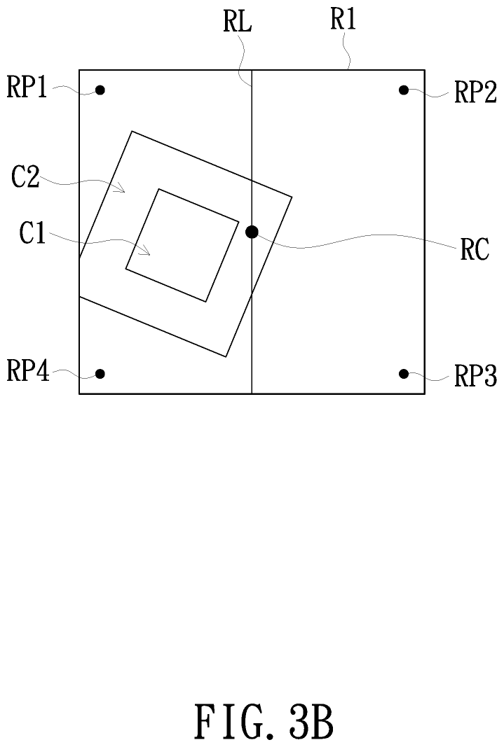

Referring to FIG. 4A to FIG. 4F, FIG. 4A to FIG. 4F show a schematic diagram of another landing state of the UAV landing system 1 shown in FIG. 1. As shown in FIG. 4A, compared to the height h5 of FIG. 3A, the UAV 10 of FIG. 4A has descended to a lower height h2 relative to the target area 100, that is, the height h2 is lower than the height h5. FIG. 4B to FIG. 4F are schematic diagrams showing the reference images R2˜R6 generated by the image capture device 11 capturing the image below the UAV 10. The processor 12 determines whether the colors of the reference points RP1, RP2, RP3, and RP4 are all the second color C2; if the determined result is yes, the processor 12 controls the controller 13 to drive the UAV 10 to move downward by a predetermined distance (not shown in FIG. 4A to FIG. 4F) toward the target area 100. If the determined result is no, the processor 12 determines whether the reference points RP1, RP2, RP3, and RP4 include the reference point of the first color C1; if the determined result is yes, the processor 12 sets the direction from the center RC of the reference image to the reference point of the first color C1 is the flight adjustment direction, and the processor 12 controls the controller 13 to drive the UAV 10 to fly along the flight adjustment direction.

When the processor 12 determines that the colors of the reference points RP1, RP2, RP3, and RP4 are not the first color C1, the processor 12 determines whether the reference points RP1, RP2, RP3, and RP4 include the reference point of the second color C2; if the determined result is yes, the processor 12 sets the direction from the center RC of the reference image to the reference point of the second color C2 is the flight adjustment direction, and the processor 12 controls the controller 13 to drive the UAV 10 to fly along the flight adjustment direction. Therefore, by determining the colors of the reference points RP1, RP2, RP3, and RP4 to adjust the flight direction of the UAV 10, the UAV 10 can finally move to the upper area right above the target area 100, and then continue the landing process. The specific operation details will be described in detail with embodiments of FIG. 4B to FIG. 4F.

In the embodiment of FIG. 4B, the processor 12 determines that the colors of the reference points RP1, RP2, RP3, and RP4 of the reference image R2 are not the first color C1. Next, the processor 12 determines that the reference points RP1, RP2, RP3, and RP4 of the reference image R2 include the reference point RP1 of the second color C2. Therefore, the processor 12 sets the direction from the center RC of the reference image R2 to the reference point RP1 of the second color C2 is the flight adjustment direction f1. The processor 12 controls the controller 13 to drive the UAV 10 to fly along the flight adjustment direction f1, bringing the UAV 10 closer to the upper area right above the target area 100.

In the embodiment of FIG. 4C, the processor 12 determines that the reference points RP1, RP2, RP3, and RP4 of the reference image R3 include the reference point RP1 of the first color C1. Therefore, the processor 12 sets the direction from the center RC of the reference image R3 to the reference point RP1 of the first color C1 is the flight adjustment direction f2. The processor 12 controls the controller 13 to drive the UAV 10 to fly along the flight adjustment direction f2, bringing the UAV 10 closer to the upper area right above the target area 100.

In the embodiment of FIG. 4D, the processor 12 determines that the colors of the reference points RP1, RP2, RP3, and RP4 of the reference image R4 are not the first color C1. Next, the processor 12 determines that the reference points RP1, RP2, RP3, and RP4 of the reference image R4 include the reference points RP2 and RP3 of the second color C2. At this time, the processor 12 sets the direction from the center RC of the reference image R4 to the geometric center GC1 of the reference points RP2 and RP3 of the second color C2 is the flight adjustment direction f3. The processor 12 controls the controller 13 to drive the UAV 10 to fly along the flight adjustment direction f3, bringing the UAV 10 closer to the upper area right above the target area 100. It is worth to notice, that when the processor 12 determines that the reference points RP1, RP2, RP3, and RP4 include a plurality of reference points of the second color C2, the movement toward the geometric center of these reference points is only an example, to which the invention is not limited. As long as the processor 12 drives the UAV 10 to fly toward these reference points is sufficient.

In the embodiment of FIG. 4E, similarly, the processor 12 determines that the reference points RP1, RP2, RP3, and RP4 of the reference image R5 include the reference points RP2, RP3 and RP4 of the second color C2. The processor 12 controls the controller 13 to drive the UAV 10 to fly toward the geometric center of the reference points RP2, RP3 and RP4, and details are not described again.

In the embodiment of FIG. 4F, the processor 12 determines that the colors of the reference points RP1, RP2, RP3, and RP4 are all the second color C2, that is, the UAV 10 is already in the upper area of the target area 100, and the process of landing can be further carried out. Therefore, the processor 12 controls the controller 13 to drive the UAV 10 to move downward by a predetermined distance to bring the height of the UAV 10 closer to the target area 100. The way in which the processor 12 controls the controller 13 to drive the UAV 10 to move downward by a predetermined distance toward the target area 100 can be implemented by the barometer (not shown in the figures), the sonar (not shown in the figures), the gyroscope (not shown in the figures), the magnetometer (not shown in the figures), the accelerometer (not shown in the figures), the satellite navigation system 15 or the lidar 17, to which the invention is not limited.

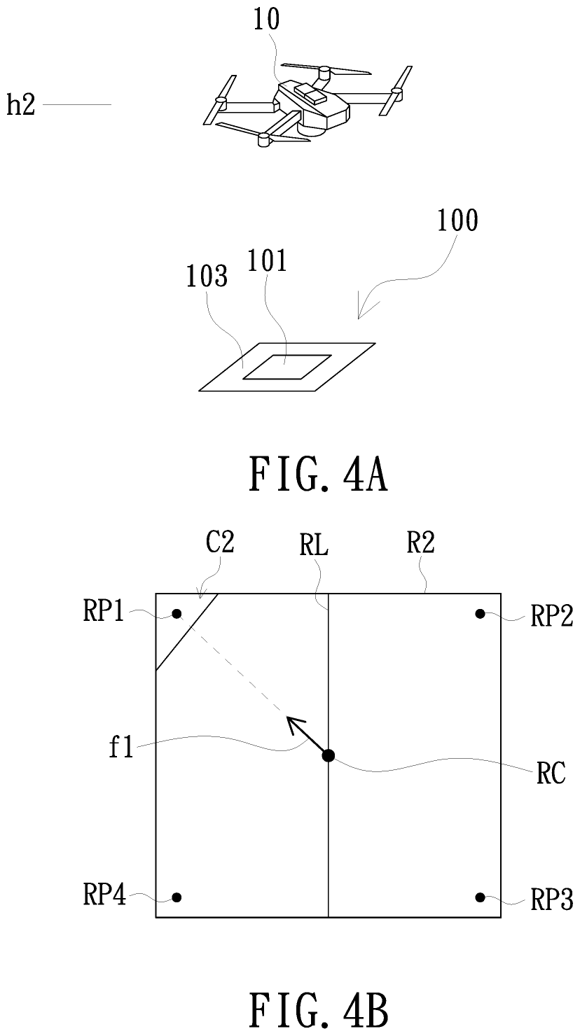

Referring to FIG. 5A to FIG. 5D, FIG. 5A to FIG. 5D show a schematic diagram of still another landing state of the UAV landing system 1 shown in FIG. 1. As shown in FIG. 5A, compared to the height h2 of FIG. 4A, the UAV 10 of FIG. 5A has descended to a lower height h1 relative to the target area 100, that is, the height h1 is lower than the height h2. FIG. 5B to FIG. 5D are schematic diagrams showing the reference images R7˜R9 generated by the image capture device 11 capturing the image below the UAV 10. The processor 12 determines whether the colors of the reference points RP1, RP2, RP3, and RP4 are all the first color C1; if the determined result is yes, the processor 12 controls the controller 13 to drive the UAV 10 to move downward toward the target area 100. If the determined result is no, the processor 12 determines whether the reference points RP1, RP2, RP3, and RP4 include the reference point of the first color C1; if the determined result is yes, the processor 12 sets the direction from the center RC of the reference image to the reference point of the first color C1 is the flight adjustment direction, and the processor 12 controls the controller 13 to drive the UAV 10 to fly along the flight adjustment direction.

When the processor 12 determines that at least two of the reference points RP1, RP2, RP3, and RP4 are not the first color C1, and the processor 12 determines that the number of other reference points of the first color C1 of these reference points is more than two, the processor 12 sets the direction from the center RC of the reference image to the geometric center of the other reference points of the first color C1 is the flight adjustment direction, and the processor 12 controls the controller 13 to drive the UAV 10 to fly along the flight adjustment direction. Therefore, by determining the colors of the reference points RP1, RP2, RP3, and RP4 to adjust the flight direction of the UAV 10, the UAV 10 can finally move to the upper area of the target area 100. The specific operation details will be described in detail with the examples of FIG. 5B to FIG. 5D.

In the example of FIG. 5B, the processor 12 determines that the reference points RP1, RP2, RP3, and RP4 of reference image R7 include the reference point RP1 of the first color C1. The processor 12 sets the direction from the center RC of the reference image R7 to the reference point RP1 of the first color C1 is the flight adjustment direction f4. The processor 12 controls the controller 13 to drive the UAV 10 to fly along the flight adjustment direction f4, bringing the UAV 10 closer to the upper area of the target area 100.

In the example of FIG. 5C, the processor 12 determines that the reference points RP1, RP2, RP3, and RP4 of the reference image R8 include the reference points RP1 and RP4 of the first color C1. At this time, the processor 12 sets the direction from the center RC of the reference image R8 to the geometric center GC2 of the reference points RP1 and RP4 of the first color C1 is the flight adjustment direction f5. The processor 12 controls the controller 13 to drive the UAV 10 to fly along the flight adjustment direction f5, bringing the UAV 10 closer to the upper area of the target area 100. It is worth to notice, that when the processor 12 determines that the reference points RP1, RP2, RP3, and RP4 include a plurality of reference points of the first color C1, the movement toward the geometric center of these reference points is only an example, to which the invention is not limited. As long as the processor 12 controls the controller 13 to drive the UAV 10 to fly toward these reference points is sufficient.

In the example of FIG. 5D, the processor 12 determines that the colors of the reference points RP1, RP2, RP3, and RP4 of the reference image R9 are all the first color C1, that is, the UAV 10 is already in the upper area of the target area 100, and the process of landing can be further carried out. Therefore, the processor 12 could control the controller 13 to drive the UAV 10 to move downward toward the target area 100, for example, the UAV 10 can be landed in the target area 100. By analyzing the reference image to control the flight of the UAV 10, the UAV 10 can automatically and accurately land in the target area 100.

Incidentally, in the embodiment shown in FIG. 1 to FIG. 5D, if the UAV 10 is affected by various other factors such as turbulence, and the processor 12 determines that the colors of the reference points RP1, RP2, RP3, and RP4 are not the first color C1 or the second color C2, the processor 12 can again control the controller 13 to drive the UAV 10 to move toward the target area 100 according to the navigation signal DS1 provided by the satellite navigation system 15 and/or the orientation signal DS2 provided by the lidar 17, bringing the UAV 10 to the upper area of the target area 100.

In detail, the processor 12 can set at least two reference points on the reference image captured by the image capture device 11 for analysis, and the at least two reference points, for example, are uniformly distributed around the surrounding area of the reference image. In the embodiment shown in FIG. 1 to FIG. 5D, the reference points RP1, RP2, RP3, and RP4 are uniformly distributed around the four corners of the reference image. For example, the reference image captured by the image capture device 11, for example, may be a 250-pixel by 250-pixel image, and the reference points RP1, RP2, RP3, and RP4, for example, could be pixel points 5 pixels apart from two adjacent sides. By the at least two reference points uniformly distributed around the surrounding area of the reference image, the UAV 10 can be accurately and automatically landed on the target area 100. It is worth to notice, that in the embodiment shown in FIG. 1 to FIG. 5D, the shapes of the first reference area 101 and the second reference area 103 of the target area 100 and the reference image captured by the image capture device 11 are rectangular as an example, to which the invention is not limited. In other embodiments of the invention, the shapes of the first reference area, the second reference area and the reference image, for example, could be circular.

In addition, the shape of the first reference area 101, for example, could be a rectangle, the frame of the second reference area 103, for example, could be a rectangle, the frame of the second reference area 103 surrounds the frame of the first reference area 101, and the four sides of the frame of the second reference area 103 are respectively parallel to the four sides of the frame of the first reference area 101. The processor 12 could set a reference line RL in the reference image captured by the image capture device 11. The processor 12 sets the image of the side of the frame of the first reference area 101 and/or the second reference area 103 in the reference image as the reference line segments. The processor 12 could determine the direction in which the UAV 10 is horizontally rotated relative to the target area 100 according to the angle between the reference line RL and the reference line segments. In this way, the nose (not shown) of the UAV 10 can be rotated horizontally to a specific direction. For example, the processor 12 could control the UAV 10 to rotate horizontally such that the reference line RL is parallel or perpendicular to the reference line segment. The specific operation details will be described in detail with the examples of FIG. 4E to FIG. 4F and FIG. 5C to FIG. 5D.

As shown in FIG. 4A and FIG. 4E, when the UAV 10 is at the height h2, the image of the first reference area 101 in the reference image R5 is the image i101, one side of the frame of the image i101 in the reference image R5 is the reference line segment 101a in the reference image R5, and the reference line RL and the reference line segment 101a include an angle A1. The processor 12 can control the UAV 10 to rotate horizontally according to the analyzed angle A1, so that the reference line RL in the reference image captured by the image capture device 11 is perpendicular to the reference line segment 101a (as shown in FIG. 4F). As shown in FIG. 5A and FIG. 5C, when the UAV 10 is at the height h1, one side of the frame of the image corresponding to the first reference area 101 in the reference image R8 is the reference line segment 101b in the reference image R8, the reference line RL and the reference line segment 101b include an angle A2. The processor 12 can control the UAV 10 to rotate horizontally according to the analyzed angle A2, so that the reference line RL in the reference image captured by the image capture device 11 is parallel or perpendicular to the reference line segment 101b.

For example, a charging electrode (not shown) could be provided on the target area 100 to charge the UAV 10. Rotating the nose of the UAV 10 horizontally to the specific direction, for example, lets the UAV 10 to properly land to the position that could be in contact with the charging electrode. Incidentally, the UAV 10, for example, can also assist in adjusting the horizontal direction of the UAV 10 by the barometer (not shown in the figures), the sonar (not shown in the figures), the gyroscope (not shown in the figures), the magnetometer (not shown in the figures), the accelerometer (not shown in the figures), the satellite navigation system 15 or the lidar 17, to which the invention is not limited. The form and position of the reference line RL of the reference image in the embodiment shown in FIG. 1 to FIG. 5D are merely exemplified, to which the invention is not limited. As long as the reference line could have characteristics (e.g., an included angle) corresponding to the image of the side of the frame of the first reference area 101 and/or the second reference area 103 in the reference image, and the processor 12 could control the UAV 10 to rotate horizontally according to these characteristics is sufficient.

Incidentally, the shape of the first reference area 101 of the UAV landing system 1 is a geometric shape. The image capture device 11 could capture a first reference image at a first time and capture a second reference image at a second time. The processor 12 could analyze the image corresponding to the first reference area 101 in the first reference image and the second reference image to control the direction in which the controller 13 drives the UAV 10 to rotate horizontally. The details will be described with the examples of FIG. 4D to FIG. 4F.

As shown in FIG. 4D, the shape of the first reference area 101 is rectangular. The image capture device 11 could capture a first reference image (ie, the reference image R4) at a first time (T=t1), and the processor 12 first determines the color of the reference point of the first reference image (ie, the reference image R4), and sets the direction from the center RC of the first reference image (ie, the reference image R4) to the geometric center GC1 of the reference points RP2 and RP3 of the second color C2 is the flight adjustment direction f3. The processor 12 controls the controller 13 to drive the UAV 10 to fly along the flight adjustment direction f3. As shown in FIG. 4E, after the UAV 10 flies along the flight adjustment direction f3, the image capture device 11 could capture a second reference image (ie, the reference image R5) at a second time (T=t2), and the processor 12 first determines that the reference points RP1, RP2, RP3, and RP4 of the second reference image (ie, the reference image R5) include reference points RP2, RP3, and RP4 of the second color C2. The processor 12 controls the controller 13 to drive the UAV 10 to fly toward the geometric center of the reference points RP2, RP3, and RP4. The processor 12 could analyze the image corresponding to the first reference area 101 in the first reference image and the second reference image to control the direction in which the controller 13 drives the UAV 10 to rotate horizontally. For example, in the reference image R4 of FIG. 4D, the image corresponding to the first reference area 101 is closer to the right side of the reference image R4. In comparison, in the reference image R5 of FIG. 4E, the image corresponding to the first reference area 101 is closer to the middle of the reference image R5. In the reference image R4, the image corresponding to the first reference area 101 has a larger angle with the vertical line or the horizontal line. In comparison, in the reference image R5, the image corresponding to the side of the outer frame of the first reference area 101 has the smaller angle with the vertical line or the horizontal line. The processor 12 could analyze these characteristics to control the controller 13 to drive the UAV 10 to rotate horizontally, so that the UAV 10 could rotate horizontally to the specific direction. For example, as shown in FIG. 4F, after the processor 12 analyzes the image corresponding to the first reference block 101 in the first reference image and the second reference image to control the controller 13 to drive the UAV 10 to rotate horizontally, in the reference image R6 captured by the image capture device 11 at the third time (T=t3), the image corresponding to the side of the frame of the first reference area 101 is perpendicular or parallel to the vertical line or the horizontal line.

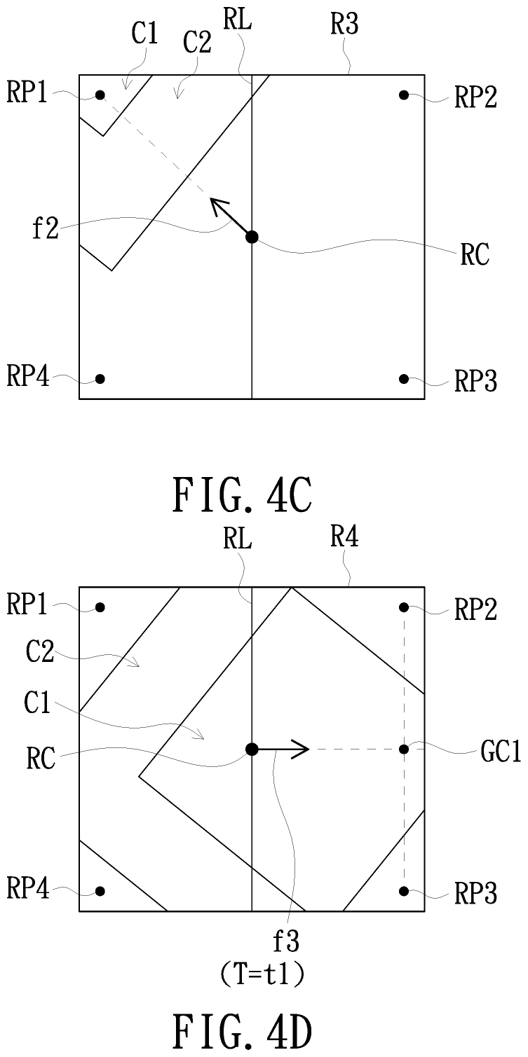

Referring to FIG. 6, which is a schematic diagram of an UAV landing system according to another embodiment of the invention. The UAV landing system 2 includes an UAV 10 and a target area 200. The UAV landing system 2 of the embodiment has a similar structure and function as the UAV landing system 1 shown in FIG. 1 to FIG. 5. The embodiment shown in FIG. 6 is different from the embodiment shown in FIG. 1 to FIG. 5 in that the target area 200 further includes at least two Nth reference areas, and N is a positive integer of 2 or more. The second reference area 103 surrounds the first reference area 101, the Nth reference area surrounds the Nth−1 reference area, and the color of the Nth reference area is an Nth color. The embodiment shown in FIG. 6 is exemplified by N=4, to which the invention is not limited. The target area 200 includes the first reference area 101, the second reference area 103, the third reference area 205, and the fourth reference area 207, wherein the second reference area 103 surrounds the first reference area 101, the third reference area 205 surrounds the second reference area 103, and the fourth reference area 207 surrounds the third reference area 205. The color of the first reference area 101 is the first color C1, the color of the second reference area 103 is the second color C2, the color of the third reference area 205 is the third color C3, the color of the fourth reference area 207 is the fourth color C4, and the colors of the first color C1, second color C2, third color C3, and fourth color C4 are different.

Similar to the method of the embodiment of FIG. 1 to FIG. 5D, the processor 12 of the UAV 10 determines whether the colors of the at least two reference points captured by the image capture device are all the Nth color; if the determined result is yes, the processor 12 controls the controller 13 to drive the UAV 10 to move downward by a predetermined distance d toward the target area 100. If the determined result is no, the processor 12 determines whether the at least two reference points include the reference point of the first color C1; if the determined result is yes, the processor 12 set the direction from the center of the reference image to the reference point of the first color C1 is the flight adjustment direction, and the processor 12 controls the controller 13 to drive the UAV 10 to fly along the flight adjustment direction.

For example, in the embodiment, when the UAV 10 is at the height h4, the processor 12 determines that the colors of at least two reference points in the reference image captured by the image capture device 11 are the fourth color C4, the processor 12 controls the controller 13 to drive the UAV 10 to move downward by a predetermined distance d to the target area 200, let the height of the UAV 10 drop from the height h4 to the height h3. When the UAV 10 is at the height h3, the processor 12 determines that the color of at least two reference points in the reference image captured by the image capture device 11 is the third color C3, the processor 12 controls the controller 13 to drive the UAV 10 to move downward by a predetermined distance d to the target area 200, let the height of the UAV 10 drop from the height h3 to the height h2. By analogy, the UAV 10 can automatically land on the target area 200 accurately.

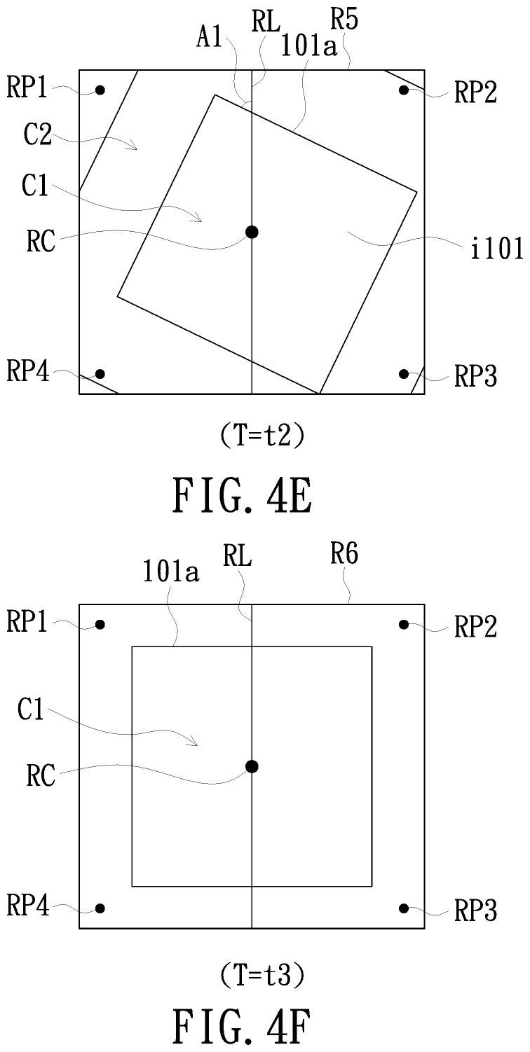

FIG. 7 shows a flowchart of a UAV landing method according to an embodiment of the invention. Referring to FIG. 7, in step S101, the processor of the UAV controls the controller to drive the UAV to move in the direction of the target area according to a navigation signal and/or an orientation signal. Next, in step S103, the UAV turns on the operation of the image capture device and captures the image below the UAV by the image capture device to generate a reference image (this step can be omitted). In step 105, the processor determines whether at least two reference points in the reference image include the reference point of the first color or the second color; if yes, proceed to step S109; if not, proceed to step S107. In step S107, the processor controls the controller to drive the UAV to move downward and the image capture device continuously captures the image until the processor determines that the at least two reference points in the reference image captured by the image capture device include the reference point of the first color or the second color, and the processor controls the controller to drive the UAV to stop moving downward.

In step S109, the processor determines whether the colors of the at least two reference points in the reference image captured by the image capture device are all the second color; if yes, proceed to step S111; if not, proceed to step S113. In step S111, the processor controls the controller to drive the UAV to move downward by a predetermined distance toward the target area, and then proceeds to step S121. In step S113, the processor determines whether the at least two reference points in the reference image captured by the image capture device include the reference point of the first color; if yes, proceed to step S115; if not, proceed to step S117. In step S115, the processor sets that the direction from the center of the reference image to the reference point of the first color is the flight adjustment direction, and the processor controls the controller to drive the UAV to fly along the flight adjustment direction. In step S117, the processor determines whether the at least two reference points in the reference image captured by the image capture device include the reference point of the second color; if yes, proceed to step S119; if not, return to step S101. In step S119, the processor sets that the direction from the center of the reference image to the reference point of the second color is the flight adjustment direction, and the processor controls the controller to drive the UAV to fly along the flight adjustment direction, and then proceeds to step S109.

In step S121, the processor determines whether the colors of the at least two reference points in the reference image captured by the image capture device are all the first color; if yes, proceed to step S123; if not, return to step S125. In step S123, the processor controls the controller to drive the UAV to move downward toward the target area. In step S125, the processor determines whether the at least two reference points in the reference image captured by the image capture device include the reference point of the first color; if yes, proceed to step S127; if not, return to step S105. In step S127, the processor sets that the direction from the center of the reference image to the reference point of the first color is the flight adjustment direction, and the processor controls the controller to drive the UAV to fly along the flight adjustment direction, and then proceeds to step S121. By analyzing the reference image to control the flight path of the UAV, the UAV could accurately and automatically landed on the target area. It should be noted that, in step S103, the step of turning on the operation of the image capture device of the UAV can be omitted. The image capture device of the UAV, for example, can be turned on before proceeding to step S101.

In addition, the UAV landing method of the embodiment of the invention can be taught, suggested and implemented by the description of the embodiment of FIG. 1 to FIG. 6, and details are not described again.

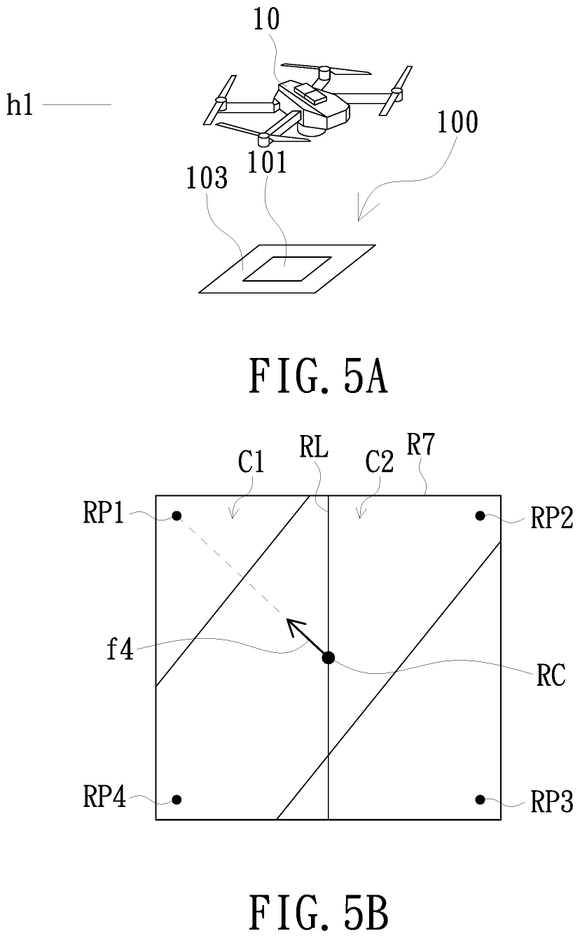

FIG. 8 shows a flowchart of an UAV landing method according to another embodiment of the invention. Referring to FIG. 8, in step S201, the processor of the UAV determines the direction in which the UAV is horizontally rotated according to the angle between a reference line and at least one reference line segment. Next, in step S203, the processor controls the controller to drive the UAV to rotate horizontally such that the reference line in the reference image captured by the image capture device 11 is parallel or perpendicular to the at least one reference line segment. The UAV landing method of the embodiment of the invention can be taught, suggested and implemented by the description of the embodiment of FIG. 1 to FIG. 6, and details are not described again.

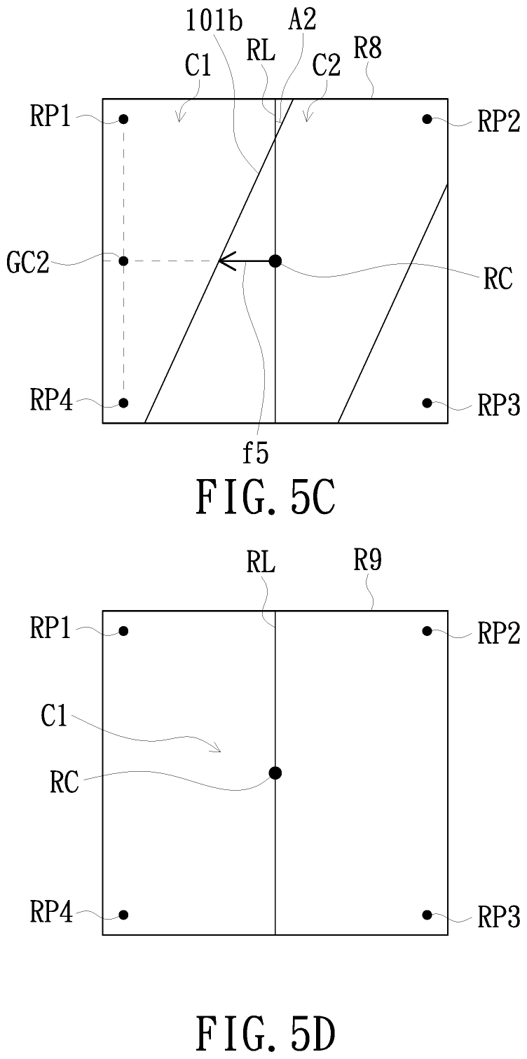

FIG. 9 shows a flowchart of an UAV landing method according to still another embodiment of the invention. Referring to FIG. 9, in step S301, the image capture device captures a first reference image at a first time. Next, in step S303, the image capture device captures a second reference image at a second time. Next, in step S305, the processor analyzes the images corresponding to the first reference area in the first reference image and the second reference image to control the direction in which the controller drives the UAV to rotate horizontally. For example, the processor could compare the difference between the images corresponding to the first reference area in the first reference image and the image corresponding to the first reference area in the second reference image to control the direction in which the controller drives the UAV to rotate horizontally. The UAV landing method of the embodiment of the invention can be taught, suggested and implemented by the description of the embodiment of FIG. 1 to FIG. 6, and details are not described again.

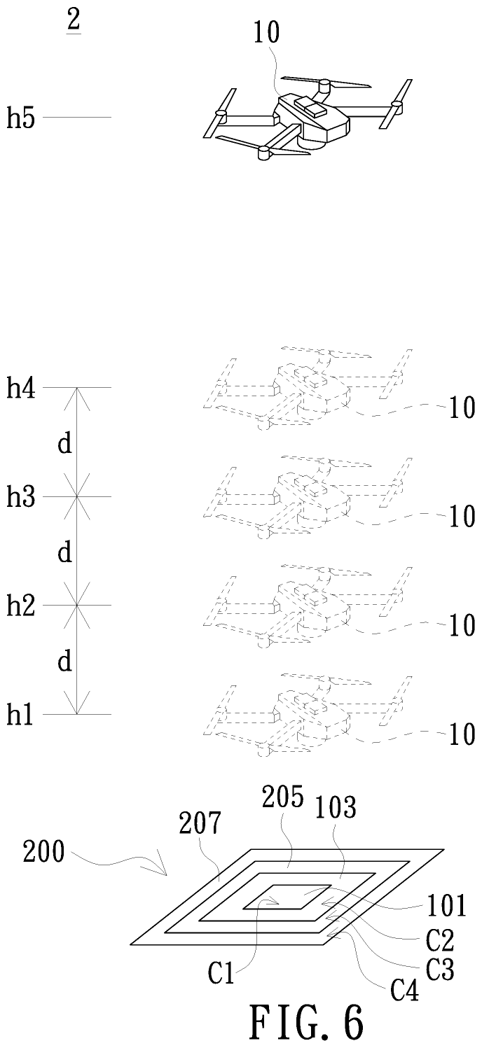

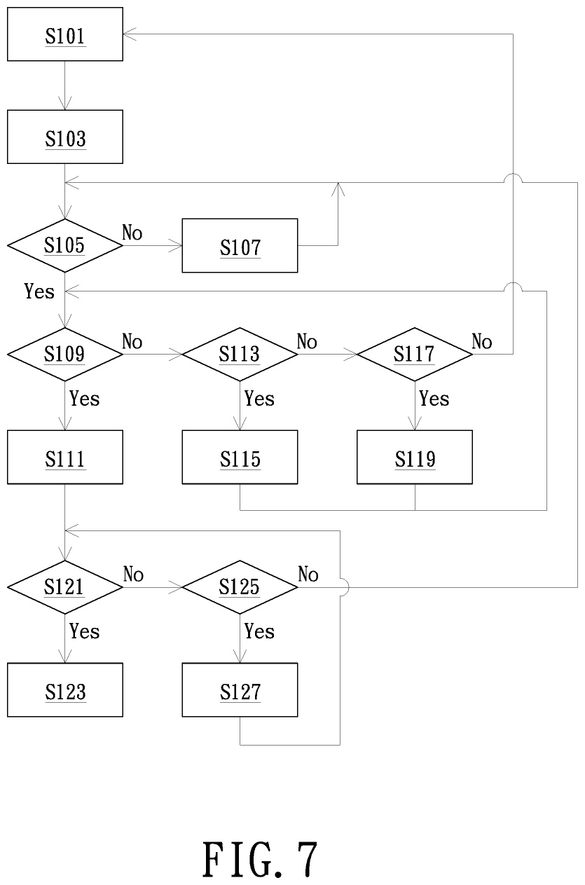

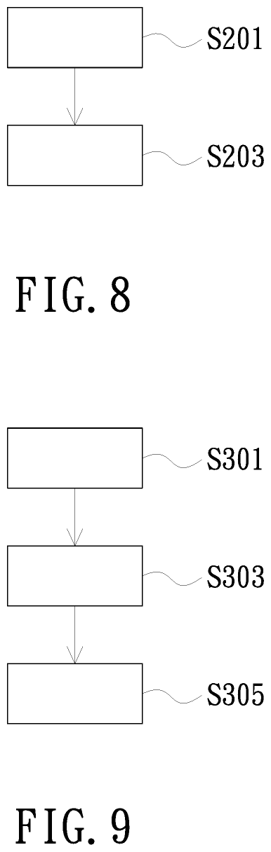

Referring to FIG. 10, FIG. 10 shows a schematic diagram of an UAV landing system according to still another embodiment of the invention. The UAV landing system 3 includes an UAV 20 and a target area 300. Please also refer to FIG. 11, FIG. 11 is the block diagram of the UAV 20 shown in FIG. 10. The UAV 20 includes a processor 12, a controller 13, image capture device 11 and a deep learning module 29. The processor 12 is coupled to the controller 13, the image capture device 11, and the deep learning module 29. The target area 300 is used for the UAV 20 to land. The target area 300 includes identification features 301, 302, 303, 305, and 306. The image capture device 11 of the UAV 20 could capture the image below the UAV 20 to generate a reference image (not shown in FIG. 10). The processor 12 of the UAV 20 determines, according to the deep learning module 29, a feature image corresponding to the identification features 301, 302, 303, 305, and 306 in the reference image and obtains a confidence level value 121. If the confidence level value 121 is insufficient, the processor 12 controls the controller 13 to drive the UAV to fly along a flight adjustment direction according to the deep learning module 29. The specific operation details will be described in detail with the examples of FIG. 12 to FIG. 16.

In the embodiment, the target area 300 is illustrated by an UAV platform, to which the invention is not limited. Target area 300 (UAV platform) is illustrated by including a base (identification feature 301), two covers (identification features 302, 303), a first electrode (identification feature 305), and a second electrode (identification feature 306). The colors of the identification features 301, 302, 303, 305, 306, for example, could include colors C301, C302, C303, C305, C306, respectively. The first cover and the second cover can move and combine, such that the base (identification feature 301) can be shielded by the two covers (identification features 302, 303) and the UAV and/or equipment in the UAV platform can be protected. The first electrode and the second electrode, for example, could charge the UAV landing on the base (identification feature 301).

FIG. 12 to FIG. 16 show a schematic diagram of a landing state of the UAV landing system 3 shown in FIG. 10. As shown in FIGS. 10-12, the image capture device 11 of the UAV 20 could capture the image below the UAV 20 to generate the reference image R11. The processor 12 of the UAV 20 could determine, according to the deep learning module 29, the feature image corresponding to the identification features 301, 302, 303, 305, and 306 in the reference image R11 and obtains a confidence level value 121. At this time, the processor 12, for example, can determine the image shape, the size, the relative position, the angle or the color C301, C302, C303, C305, C306 of the feature image corresponding to the identification features 301, 302, 303, 305, 306 in reference image R11. In the embodiment, for example, the images corresponding to the identification features 301, 302, 303, 305, 306 in the reference image R11 are feature images i301, i302, i303, i305, and i306. The processor 12, for example, could identify the feature images i301, i302, i303, i305, i306 by identifying the colors C301, C302, C303, C305, C306 of the identification features 301, 302, 303, 305, 306. The identification features 301, 302, 303, 305, 306 of the embodiment are rectangular as an example. The feature images i301, i302, i303, i305, i306 are located in the middle region of the reference image R11, and the edges of the outer frames of the feature images i301, i302, i303, i305, i306 are parallel or perpendicular to the sides of the frame of the reference image R11. This may indicate that the UAV 20 is located right above the target area 300, so that the processor 12 may generate a very high confidence level value 121 (e.g., 85%). The processor 12 can determine that the confidence level value 121 is sufficient, and control the controller 13 to drive the UAV 20 to move downward toward the target area 300. For subsequent landing action.

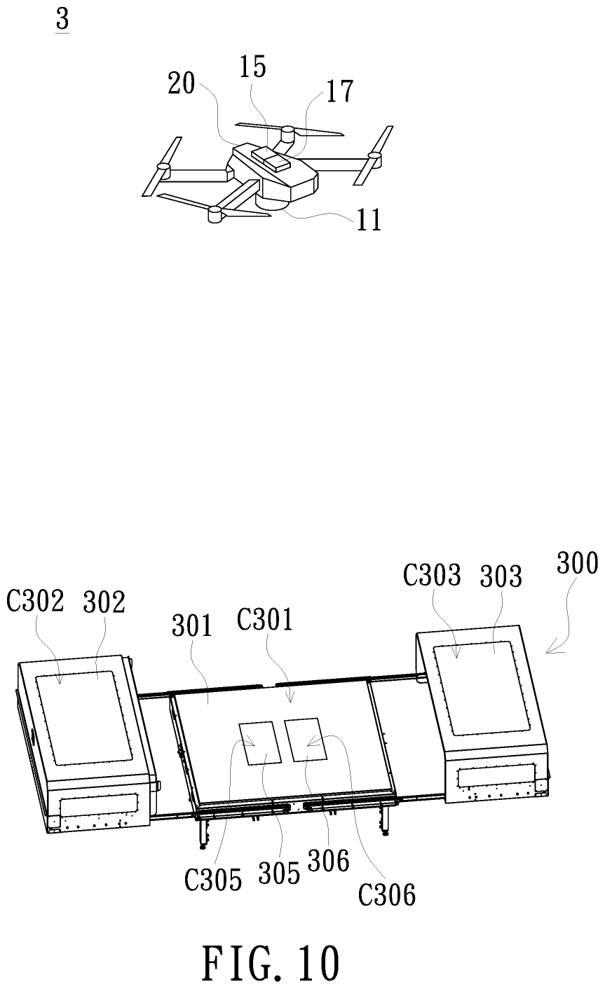

As shown in FIG. 13, the image capture device 11 of the UAV 20 could capture the image below the UAV 20 to generate the reference image R12. The feature images i301, i302, i303, i305, i306 corresponding to the identification features 301, 302, 303, 305, and 306 in the reference image R12 are located in the middle region of the reference image R12, and the feature images i301, i302, i303, i305, i306 are parallel or perpendicular to the sides of the frame of the reference image R12. Compared to the reference image R11, the feature images i301, i302, i303, i305, i306 in the reference image R12 occupy a larger area, and which may indicate that the UAV 20 is closer to the target area 300 in height. Therefore, the processor 12 can generate a higher confidence level value 121 (e.g., 95%) than the reference image R11. The processor 12 can determine that the confidence level value 121 is sufficient, and control the controller 13 to drive the UAV 20 to move toward the target zone 300 for subsequent landing action. In addition, the processor 12, for example, may also set a threshold value (not shown), and the threshold value, for example, may be 90%. When the processor 12 determines that the confidence level value 121 is greater than the threshold value, the processor 12 can control the controller 13 to drive the UAV 20 to land on the target area 300.

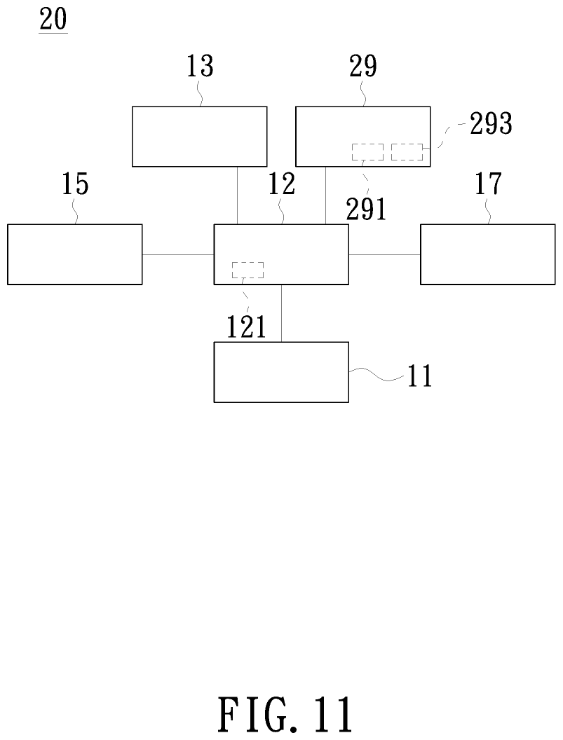

Referring to FIG. 14, the image capture device 11 of the UAV 20 capture the image below the UAV 20 and generate the reference image R13. The feature images i301, i302, i303, i305, i306 corresponding to the identification features 301, 302, 303, 305, and 306 in the reference image R13 are located in the middle region of the reference image R13, and their areas are similar to the image in the reference image R11. However, the feature images i301, i302, i303, i305, i306 in the reference image R13 are not parallel or perpendicular to the sides of the frame of the reference image R13, but have angles with the sides of the frame of the reference image R13. The embodiment is, for example, intended to let the UAV 20 properly land on the first electrode (identification feature 305) and the second electrode (identification feature 306), that is, the feature images i301, i302, i303, i305, i306 needs to be parallel or perpendicular to the sides of the frame of the reference image R13. Therefore, the processor 12 can generate a lower confidence level value 121 (e.g., 75%) than the reference image R11. The processor 12, for example, could control the UAV 20 to rotate horizontally according to the angles of the feature images i301, i302, i303, i305, i306 with respect to the sides of the frame of the reference image R13, so that the feature images i301, i302, i303, i305, i306 in the reference image captured by the image capture device 11 can be parallel or perpendicular to the sides of the frame of the reference image for the subsequent landing action.

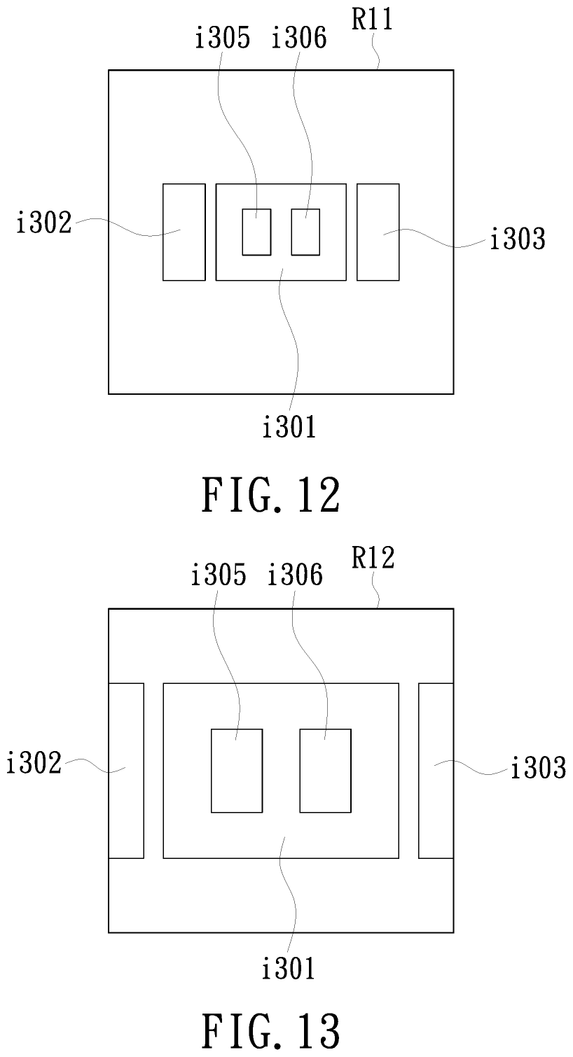

Referring to FIG. 15, the image capture device 11 of the UAV 20 capture the image below the UAV 20 and generate the reference image R14. The feature images i301, i302, i303, i305, i306 corresponding to the identification features 301, 302, 303, 305, and 306 in the reference image R14 are located in the upper left edge region of the reference image R14, and the reference image R14 only includes partial images of the feature images i301, i302, i303, i305, i306. The embodiment is intended to let the UAV 20 properly land on the base (identification feature 301), so that the processor 12 can generate a lower confidence level value 121 (e.g., 30%) than the reference image R11. At this time, the processor 12 can determine that the confidence level value 121 is insufficient, and the processor 12 could control the controller 13 to drive the UAV 20 to fly along a flight adjustment direction f6 according to the deep learning module 29. The flight adjustment direction f6, for example, may be generated by the processor 12 according to the relative positions of the feature images i301, i302, i303, i305, i306 in the reference image R14, so that the UAV 20 can fly to the upper area of the target area 300.

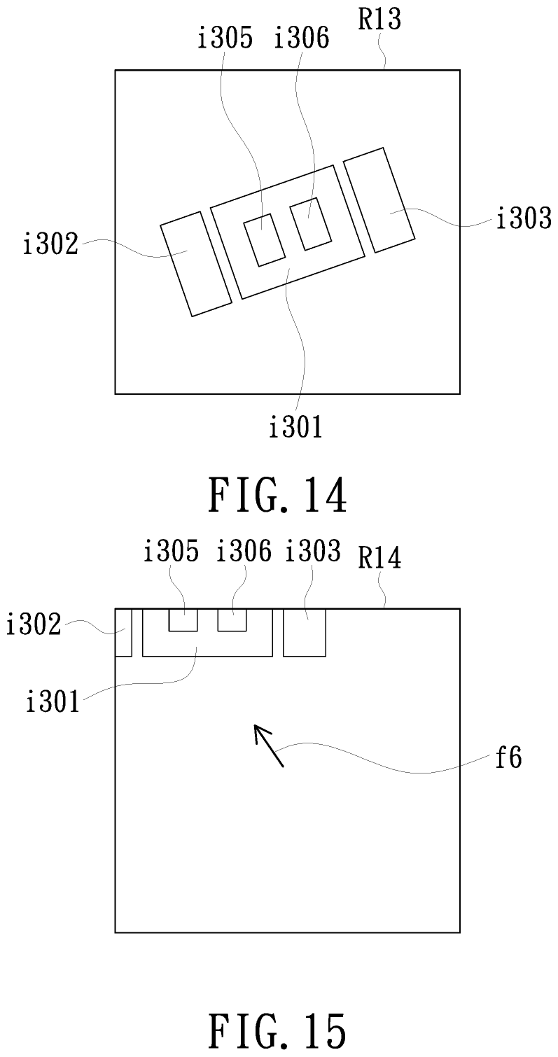

Referring to FIG. 16, the image capture device 11 of the UAV 20 capture the image below the UAV 20 and generate the reference image R15. The reference image R15 only includes the feature image i301 corresponding to the identification feature 301, the feature image i301 is located in the upper left edge region of the reference image R15, and the reference image R15 only includes a small portion of the image of the feature image i301. The embodiment is intended to let the UAV 20 properly land on the base (identification feature 301), so that the processor 12 can generate a lower confidence level value 121 (e.g., 10%) than the reference image R14. At this time, the processor 12 can determine that the confidence level value 121 is insufficient, and the processor 12 could control the controller 13 to drive the UAV 20 to fly along a flight adjustment direction f7 according to the deep learning module 29. The flight adjustment direction f7, for example, may be generated by the processor 12 according to the relative position of the feature image i301 in the reference image R15, so that the UAV 20 can fly to the upper area of the target area 300.

In addition, the deep learning module 29, for example, could include a plurality of pre-established image data 291 and motion modules 293. The plurality of image data 291 and motion modules 293 include the sample data that the UAV 20 landing in the target area several times. The image data 291 and the motion module 293 of the deep learning module 29, for example, could be established by the user operating the UAV 20 several times to land, or by the processor 12 controlling the UAV 20 to perform landing several times. The processor 12 of the UAV 20 could obtain the confidence level value 121 according to the plurality of image data 291 and motion modules 293 of the deep learning module 29, and determine whether the confidence level value 121 is sufficient. The details can be taught, suggested and implemented by the description of the embodiment of FIG. 12 to FIG. 16 and not described again.

In the embodiment, the deep learning module 29 is disposed inside the UAV 20 as an example, to which the invention is not limited. The deep learning module 29, for example, could be implemented in the firmware, the storage device, and/or the circuitry inside the UAV 20. The deep learning module, for example, also could be a server disposed in the network or the cloud, and the UAV 20 could wirelessly connect to the deep learning module.

Incidentally, the UAV 20, for example, could also include a satellite navigation system 15 and a lidar 17. The satellite navigation system 15 and the lidar 17 are coupled to the processor 12 to assist guiding the UAV 20 to approach the target area 300 to be landed. In other embodiments, the UAV 20 may not be provided with an optical radar 17, to which the invention is not limited.

The structure and form of the target area 300 of the UAV landing system 3 is only an example, to which the invention is not limited. As long as the target area includes at least one identification feature, and the deep learning module of the UAV can determine the feature image of the identification feature in the reference image and obtain the confidence level value is sufficient.

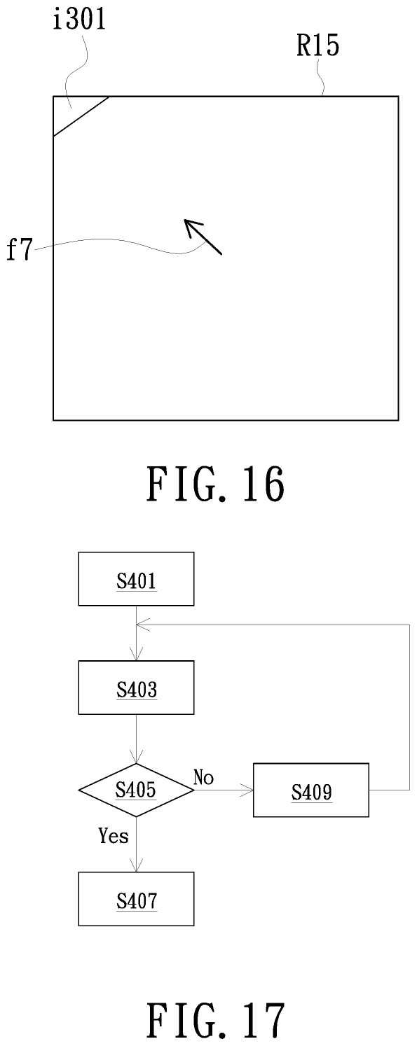

FIG. 17 shows a flowchart of a UAV landing method according to still another embodiment of the invention. Referring to FIG. 17, in step S401, the image capture device captures the image below the UAV to generate a reference image. Next, in step S403, the processor determines, according to a deep learning module, a feature image corresponding to the at least one identification feature in the reference image and obtains a confidence level value. Next, in step S405, the processor determines whether the confidence level value is sufficient; if yes, proceed to step S407; if not, proceed to step S409. In step S407, the processor controls the controller to drive the UAV to move toward the target area. In step S409, the processor controls the controller to drive the UAV to fly along a flight adjustment direction according to the deep learning module, so that the UAV could land to the target area.

In addition, the UAV landing method of the embodiment of the invention can be taught, suggested and implemented by the description of the embodiment of FIG. 10 to FIG. 16 and the details are not described again.

In summary, the UAV landing system and the UAV landing method of the embodiments of the invention can analyze the reference image captured by the image capture device to control the flight path of the UAV, so that the UAV could accurately and automatically land on the target area.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as first reference area, second reference area, third reference area, fourth reference area, first color, second color, third color, and fourth color are only used for distinguishing various elements and do not limit the number of the elements.

What is claimed is:

1. An UAV (Unmanned Aerial Vehicle) landing system, comprising: an UAV and a target area,
wherein the UAV comprises a controller, a processor, and an image capture device, and the processor is coupled to the controller and the image capture device;
wherein the target area is used for the UAV to land, the target area comprises a first reference area, and the color of the first reference area is a first color;
wherein the image capture device captures an image below the UAV to generate a reference image, the reference image comprises at least two reference points, and the at least two reference points are located in a surrounding area of the reference image;
the processor determines whether the colors of the at least two reference points are all the first color;
if the determined result is yes, the processor controls the controller to drive the UAV to move downward toward the target area;
if the determined result is no, the processor determines whether the at least two reference points comprise the reference point of the first color, if the determined result is yes, a direction from a center of the reference image to the reference point of the first color is a flight adjustment direction, and the processor controls the controller to drive the UAV to fly along the flight adjustment direction.

2. The UAV landing system according to claim 1, wherein the reference image comprises a plurality of reference points, when the processor determines that the colors of at least two of the plurality of reference points are not the first color, and the processor determines that the number of other reference points of the first color of the plurality of reference points is more than two, the direction from the center of the reference image to a geometric center of the plurality of other reference points of the first color is the flight adjustment direction, the processor controls the controller to drive the UAV to fly along the flight adjustment direction.

3. The UAV landing system according to claim 1, wherein the UAV further comprises a satellite navigation system and/or a lidar, the satellite navigation system and/or the lidar are coupled to the processor, and when the processor determines that the colors of the at least two reference points are not the first color, the processor controls the controller according to a navigation signal provided by the satellite navigation system and/or an orientation signal provided by the lidar to drive the UAV to move toward the target area.

4. The UAV landing system according to claim 1, wherein the target area also comprises a second reference area, the second reference area surrounds the first reference area, the color of the second reference area is a second color, the processor determines whether the colors of the at least two reference points are all the second color;
if the determined result is yes, the processor controls the controller to drive the UAV to move downward by a predetermined distance toward the target area;
if the determined result is no, the processor determines whether the at least two reference points comprise the reference point of the first color, and if the determined result is yes, the direction from the center of the reference image to the reference point of the first color is the flight adjustment direction, and the processor controls the controller to drive the UAV to fly along the flight adjustment direction.

5. The UAV landing system according to claim 4, wherein when the processor determines that the colors of the at least two reference points are not the first color, the processor determines whether the at least two reference points comprise the reference point of the second color, and if the determined result is yes, the direction from the center of the reference image to the reference point of the second color is the flight adjustment direction, and the processor controls the controller to drive the UAV to fly along the flight adjustment direction.

6. The UAV landing system according to claim 5, wherein the UAV also comprises a satellite navigation system and/or a lidar, the satellite navigation system and/or the lidar are coupled to the processor, and when the processor determines that the colors of the at least two reference points are not the first color or the second color, the processor controls the controller according to a navigation signal provided by the satellite navigation system and/or an orientation signal provided by the lidar to drive the UAV to move toward the target area.

7. The UAV landing system according to claim 6, wherein the processor controls the controller to drive the UAV to move to an upper area of the target area according to the navigation signal and/or the orientation signal, and when the processor determines that the colors of the at least two reference points are not the first color or the second color, the processor controls the controller to drive the UAV to move downward until the processor determines that the at least two reference points comprise the reference point of the first color or the second color, and the processor controls the controller to drive the UAV to stop moving downward.

8. The UAV landing system according to claim 1, wherein the at least two reference points are uniformly distributed around the surrounding area of the reference image.

9. The UAV landing system according to claim 1, wherein the target area further comprises at least two Nth reference areas, N is a positive integer of 2 or more, the second reference area surrounds the first reference area, the Nth reference area surrounds the Nth−1 reference area, and the color of the Nth reference area is an Nth color;
the processor determines whether the colors of the at least two reference points are all the Nth color;
if the determined result is yes, the processor controls the controller to drive the UAV to move downward by a predetermined distance toward the target area;
if the determined result is no, the processor determines whether the at least two reference points comprise the reference point of the first color, if the determined result is yes, the direction from the center of the reference image to the reference point of the first color is the flight adjustment direction, and the processor controls the controller to drive the UAV to fly along the flight adjustment direction.

10. The UAV landing system according to claim 9, wherein a shape of the first reference area is a rectangle, a frame of the Nth reference area is a rectangle, four sides of the frame of the Nth reference area are respectively parallel to four sides of a frame of the first reference area, the reference image captured by the image capture device comprises a reference line, the image of the side of the frame of the first reference area and/or the Nth reference area in the reference image is at least one reference line segment, and the processor determines a direction in which the UAV is horizontally rotated according to an angle between the reference line and the at least one reference line segment.

11. The UAV landing system according to claim 10, wherein the processor controls the controller to drive the UAV to rotate horizontally such that the reference line is parallel or perpendicular to the at least one reference line segment.

12. The UAV landing system according to claim 1, wherein a shape of the first reference area is a geometric shape, the image capture device captures a first reference image at a first time and captures a second reference image at a second time, and the processor analyzes the image corresponding to the first reference area in the first reference image and the second reference image to control the direction in which the controller drives the UAV to rotate horizontally.

13. An UAV landing method for landing an UAV to a target area, the UAV comprises a controller, a processor, and an image capture device, the processor is coupled to the controller and the image capture device, the target area is used for the UAV to land, the target area comprises a first reference area, and the color of the first reference area is a first color, and the UAV landing method comprises the following steps:
wherein the image capture device captures an image below the UAV to generate a reference image, the reference image comprises at least two reference points, and the at least two reference points are located in a surrounding area of the reference image;
the processor determines whether the colors of the at least two reference points are all the first color;
if the determined result is yes, the processor controls the controller to drive the UAV to move downward toward the target area; and
if the determined result is no, the processor determines whether the at least two reference points comprise the reference point of the first color, if the determined result is yes, a direction from a center of the reference image to the reference point of the first color is a flight adjustment direction, and the processor controls the controller to drive the UAV to fly along the flight adjustment direction.

14. The UAV landing method according to claim 13, wherein the reference image comprises a plurality of reference points, when the processor determines that the colors of at least two of the plurality of reference points are not the first color, and the processor determines that the number of other reference points of the first color of the plurality of reference points is more than two, the direction from the center of the reference image to a geometric center of the plurality of other reference points of the first color is the flight adjustment direction, and the processor controls the controller to drive the UAV to fly along the flight adjustment direction.

15. The UAV landing method according to claim 13, wherein the UAV further comprises a satellite navigation system and/or a lidar, the satellite navigation system and/or the lidar are coupled to the processor, and when the processor determines that the colors of the at least two reference points are not the first color, the processor controls the controller according to a navigation signal provided by the satellite navigation system and/or an orientation signal provided by the lidar to drive the UAV to move toward the target area.

16. The UAV landing method according to claim 13, wherein the target area further comprises a second reference area, the second reference area surrounds the first reference area, the color of the second reference area is a second color, and the UAV landing method further comprises the following steps:
the processor determines whether the colors of the at least two reference points are all the second color;
if the determined result is yes, the processor controls the controller to drive the UAV to move downward by a predetermined distance toward the target area;
if the determined result is no, the processor determines whether the at least two reference points comprise the reference point of the first color, and if the determined result is yes, the direction from the center of the reference image to the reference point of the first color is the flight adjustment direction, and the processor controls the controller to drive the UAV to fly along the flight adjustment direction.

17. The UAV landing method according to claim 16, wherein when the processor determines that the colors of the at least two reference points are not the first color, the processor determines whether the at least two reference points comprise the reference point of the second color, and if the determined result is yes, the direction from the center of the reference image to the reference point of the second color is the flight adjustment direction, and the processor controls the controller to drive the UAV to fly along the flight adjustment direction.

18. The UAV landing method according to claim 17, wherein the UAV also comprises a satellite navigation system and/or a lidar, the satellite navigation system and/or the lidar are coupled to the processor, the UAV landing method further comprises the following steps:
when the processor determines that the colors of the at least two reference points are not the first color or the second color, the processor controls the controller according to a navigation signal provided by the satellite navigation system and/or an orientation signal provided by the lidar to drive the UAV to move toward the target area.

19. The UAV landing method according to claim 18, further comprises the following steps:
the processor controls the controller to drive the UAV to move to an upper area of the target area according to the navigation signal and/or the orientation signal, and
when the processor determines that the colors of the at least two reference points are not the first color or the second color, the processor controls the controller to drive the UAV to move downward until the processor determines that the at least two reference points comprise the reference point of the first color or the second color, and the processor controls the controller to drive the UAV to stop moving downward.

20. The UAV landing method according to claim 13, wherein the at least two reference points are uniformly distributed around the surrounding area of the reference image.

21. The UAV landing method according to claim 13, wherein the target area further comprises at least two Nth reference areas, N is a positive integer of 2 or more, the second reference area surrounds the first reference area, the Nth reference area surrounds the Nth−1 reference area, a color of the Nth reference area is an Nth color, and the UAV landing method further comprises the following steps:
the processor determines whether the colors of the at least two reference points are all the Nth color;
if the determined result is yes, the processor controls the controller to drive the UAV to move downward by a predetermined distance toward the target area;
if the determined result is no, the processor determines whether the at least two reference points comprise the reference point of the first color, if the determined result is yes, the direction from the center of the reference image to the reference point of the first color is the flight adjustment direction, and the processor controls the controller to drive the UAV to fly along the flight adjustment direction.

22. The UAV landing method according to claim 21, wherein a shape of the first reference area is a rectangle, a frame of the Nth reference area is a rectangle, four sides of the frame of the Nth reference area are respectively parallel to four sides of a frame of the first reference area, the reference image captured by the image capture device comprises a reference line, the image of the side of the frame of the first reference area and/or the Nth reference area in the reference image is at least one reference line segment, and the UAV landing method further comprises the following steps:
the processor determines the direction in which the UAV is horizontally rotated according to an angle between the reference line and the at least one reference line segment.

23. The UAV landing method according to claim 22, further comprises the following steps:
the processor controls the controller to drive the UAV to rotate horizontally such that the reference line is parallel or perpendicular to the at least one reference line segment.

24. The UAV landing method according to claim 13, wherein a shape of the first reference area is a geometric shape, the image capture device captures a first reference image at a first time and captures a second reference image at a second time, and the processor analyzes the image corresponding to the first reference area in the first reference image and the second reference image to control the direction in which the controller drives the UAV to rotate horizontally.

25. An UAV landing system, comprising: an UAV and a target area;
wherein the UAV comprises a controller, a processor, and an image capture device, and the processor is coupled to the controller and the image capture device;
wherein the target area is used for the UAV to land, and the target area comprises at least one identification feature;
wherein the image capture device captures an image below the UAV to generate a reference image;
wherein the processor determines, according to a deep learning module, a feature image corresponding to the at least one identification feature in the reference image and obtains a confidence level value;
if the confidence level value is sufficient, the processor controls the controller to drive the UAV to move toward the target area; and
if the confidence level value is insufficient, the processor controls the controller to drive the UAV to fly along a flight adjustment direction according to the deep learning module.

26. The UAV landing system according to claim 25, wherein the deep learning module comprises a plurality of pre-established image data and motion modules, and the plurality of image data and motion modules comprise the sample data that the UAV landing in the target area several times.

27. An UAV landing method for landing an UAV to a target area, the UAV comprises a controller, a processor, and an image capture device, the processor is coupled to the controller and the image capture device, the target area is used for the UAV to land, the target area comprises at least one identification feature, and the UAV landing method comprises the following steps:
the image capture device captures an image below the UAV to generate a reference image;
the processor determines, according to a deep learning module, a feature image corresponding to the at least one identification feature in the reference image and obtains a confidence level value;
if the confidence level value is sufficient, the processor controls the controller to drive the UAV to move toward the target area; and
if the confidence level value is insufficient, the processor controls the controller to drive the UAV to fly along a flight adjustment direction according to the deep learning module.

28. The UAV landing method according to claim 27, wherein the deep learning module comprises a plurality of pre-established image data and motion modules, and the plurality of image data and motion modules comprise the sample data that the UAV landing in the target area several times.

29. An UAV (Unmanned Aerial Vehicle), comprising: a controller, a processor, and an image capture device;
wherein the processor is coupled to the controller, and the image capture device is coupled to the processor;
wherein a target area is used for the UAV to land, the target area comprises a first reference area, and a color of the first reference area is a first color;
wherein the image capture device captures an image below the UAV to generate a reference image, the reference image comprises at least two reference points, and the at least two reference points are located in an=surrounding area of the reference image;
the processor determines whether the colors of the at least two reference points are all the first color;
if the determined result is yes, the processor controls the controller to drive the UAV to move downward toward the target area;
if the determined result is no, the processor determines whether the at least two reference points comprise the reference point of the first color, if the determined result is yes, a direction from a center of the reference image to the reference point of the first color is a flight adjustment direction, and the processor controls the controller to drive the UAV to fly along the flight adjustment direction.

30. An UAV (Unmanned Aerial Vehicle), comprising: a controller, a processor, and an image capture device;
wherein the processor is coupled to the controller, and the image capture device is coupled to the processor;
wherein a target area is used for the UAV to land, and the target area comprises at least one identification feature;
wherein the image capture device captures an image below the UAV to generate a reference image;
wherein the processor determines, according to a deep learning module, a feature image corresponding to the at least one identification feature in the reference image and obtains a confidence level value;
if the confidence level value is sufficient, the processor controls the controller to drive the UAV to move toward the target area; and
if the confidence level value is insufficient, the processor controls the controller to drive the UAV to fly along a flight adjustment direction according to the deep learning module.
